(19) United States
(12) Patent Application Publication
(10) Pub. No.: US 2003/0219545 A1
(43) Pub. Date: Nov. 27, 2003

(54) Apparatus and a method for the thermal coating of a surface

(75) Inventor: Ralph Herber, Bad Sackingen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sulzer Metco AG, Wohlen (CH)

(21) Appl. No.: 10/407,927

(22) Filed: Apr. 4, 2003

(30) Foreign Application Priority Data
Apr. 4, 2002 (EP) 02405263.1

(51) Int. Cl. B05D 1/08

(52) U.S. Cl. 427/446; 118/300

(57) ABSTRACT

An apparatus is proposed for the thermal coating of a surface of a workpiece (20) comprising a torch (2) for the production of a coating jet (P), wherein the torch (2) is arranged in a processing station (14) such that the coating jet (P) extends substantially perpendicular to the vertical direction, and comprising adjustment means (40; 45; 60; 70) which align the workpiece (20) such that the surface to be coated is perpendicular to the coating jet (P) during the coating process.

The invention relates to an apparatus and to a method for the thermal coating of a surface of a workpiece and to the use of such an apparatus or of such a method for the coating of inner surfaces, in particular of cylinder running surfaces in cylinder bores of a cylinder crankcase.

Thermal coating is a well established method for the direct coating or conditioning of surfaces. In particular the thermal spraying methods such as arc spraying, flame spraying, high velocity oxy-fuel spraying (HVOF) and plasma spraying are methods which are used today in many areas of industry for the production of high quality coatings, for example as wear protection layers, heat insulation layers or electrical insulation layers. Plasma spraying plays a special role in this connection because it has enormous flexibility thanks to the variety of the materials processed and to the reproducibility of the melting process or of the coating process. The coating can thus be ideally matched to the respective needs.

The development of new spraying technologies such as rotative plasma spraying continuously opens up new application areas for these coating methods. In rotative plasma spraying, the plasma torch is rotated about an axis such that the plasma jet runs on an orbit. In this way, inner coatings, that is coatings of surfaces of an interior space or inner surfaces of a workpiece, can be coated in an excellent manner.

A very important application area in the automotive industry is the coating of the cylinder running surface in the cylinder bores of the cylinder crankcase of an internal combustion engine. For this purpose, a rotating plasma torch is moved along the axis of the cylinder bore such that a coating is generated on the surface of the cylinder bore, said coating usually being reworked, for example by honing, in a subsequent processing step. It has been found that coatings can be produced in this manner which are permanently able to cope with the high tribological demands on the cylinder running surfaces in internal combustion engines.

Due to the necessity of lower manufacturing costs in the automotive industry, it is necessary to look not only for favourably priced materials, but also for manufacturing methods which are as efficient and as economical as possible. With respect to the thermal coating of cylinder running surfaces, efforts are being undertaken to make this process usable for industrial mass production. In WO-A-00/37703, for example, a processing station is disclosed for the thermal coating of cylinder running surfaces in the form of a through-flow plant in which the cylinder crankcases are transported by a transport section through a plurality of processing sections, with the thermal coating take place in one of these sections.

It is an object of the invention to provide an apparatus and a method for thermal coating which allow a more efficient and more economical coating of surfaces, particularly of the cylinder running surfaces in cylinder crankcases. The method and the apparatus should in particular also be suitable for use in industrial mass production.

The subjects of the invention which satisfy this object apparatus-wise and technically method-wise are characterised by the features of the independent claim of the respective category.

In accordance with the invention, an apparatus is therefore proposed for the thermal coating of a surface of a workpiece, comprising a torch for the production of a coating jet, with the torch being arranged at a processing station such that the coating jet extends substantially perpendicular to the vertical direction and comprising adjustment means which align the workpiece such that the surface to be coated stands perpendicular to the coating jet during the coating process.

It has been found that particularly good and uniform coatings can be achieved if the surface to be coated is vertical during the coating process. The workpiece is aligned by the adjustment means such that the surface to be coated stands perpendicular to the coating jet. Since the coating jet is propagated substantially perpendicular to the vertical direction, the coating surface is consequently aligned vertically.

The advantage resulting from the adjustment means, in particular with respect to industrial mass production with a high degree of automation, becomes clear for the example of the coating of the cylinder running surfaces of a cylinder crankcase for a V engine. If the surface to be coated should always be aligned vertically, then it is necessary with known apparatuses (through-flow plants) to coat the cylinder crankcase in two runs or passes. The cylinder crankcase must first be placed on the transport section by suitable measures such that the first row of cylinder bores is correctly aligned for the coating. After the first run, in which only one row of bores is coated, the cylinder crankcase must be repositioned on the transport section such that the symmetry axes of the second row of the cylinder bores are now correctly oriented for the coating. Only then is the second row of cylinder bores coated in a second run.

The apparatus in accordance with the invention now makes it possible for such workpieces to be coated in one run, optionally without manual intervention, that is in an automated manner. The workpiece is first aligned by means of the adjustment means such that the symmetry axis of the first row of cylinder bores is vertical, these cylinder bores are coated and then the adjustment means position the workpiece such that the symmetry axes of the second row of cylinder bores are vertical. All cylinder bores of the cylinder crankcase of a V motor can consequently be coated in only one run or pass. This example already demonstrates that the invention makes possible a significantly more efficient and more economical coating process.

It is advantageous, with respect to the industrial application, for the apparatus to be provided with a transport system which transports the workpiece into the processing station and brings it into a processing position there.

In a first embodiment, the adjustment means include an adjusting device with which the transport system is tiltable and/or pivotable at least in the region of the processing station. The transport system, including the workpiece disposed and fixed thereon, can thus be aligned such that the surface to be coated is perpendicular to the coating jet.

In accordance with a second embodiment, a holder is provided on the transport system for the reception of the workpiece, with which holder the workpiece can be tilted and/or pivoted with respect to the transport system.

In a third embodiment, the adjusting means comprise a positioning device with which the workpiece can be gripped, aligned and held in the coating station during coating. This positioning device can, for example, be a manipulator, a gripping arm or a robot.

In a fourth embodiment, a lifting device can be provided as the adjustment means with which the workpiece can be raised at least in part from the transport system. The workpiece is thus tiltable in a defined manner relative to the transport system.

An advantageous measure consists in providing at least two torches in order to coat two surfaces simultaneously. The efficiency of the apparatus can thereby be increased in dependence on the application, because the total processing period is reduced.

The torch is preferably a plasma torch, because plasma spraying is extremely flexible with respect to the materials which can be processed and the reproducibility of the coating is ensured. The torch or torches is or are respective rotatable plasma torches in view of the preferred use for inner coatings, in particular the coating of cylinder running surfaces.

The adjustment means of these embodiments can naturally also be combined with one another.

In the method in accordance with the invention for the thermal coating of a surface of a workpiece, a coating jet is produced with a torch, said coating jet extending substantially perpendicular to the vertical direction, and the workpiece is positioned by settable adjustment means such that the surface to be coated stands perpendicular to the coating jet during the coating process.

A preferred use of the apparatus in accordance with the invention or of the method in accordance with the invention is the coating of inner surfaces, in particular of cylinder running surfaces in cylinder bores of a cylinder crankcase, especially of a cylinder crankcase having at least two cylinder bores whose longitudinal axes are not parallel to one another.

The invention will be explained in the following both apparatus-wise and with respect to a technical method with reference to embodiments and to the drawing. The following are shown in the schematic drawing:

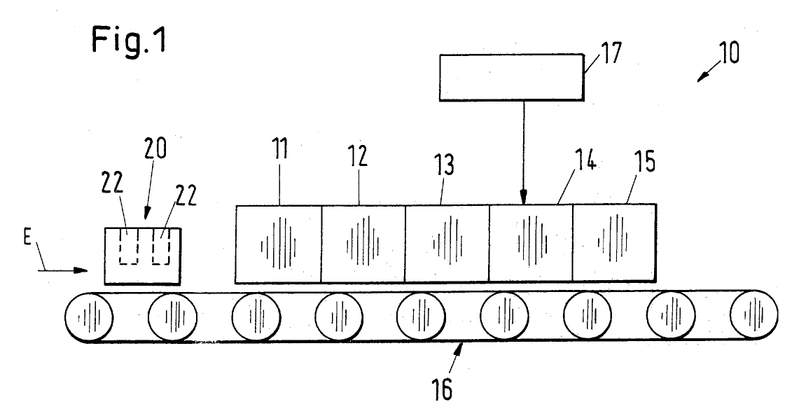

FIG. 1 a schematic representation of important components of a through-flow plant for thermal coating;

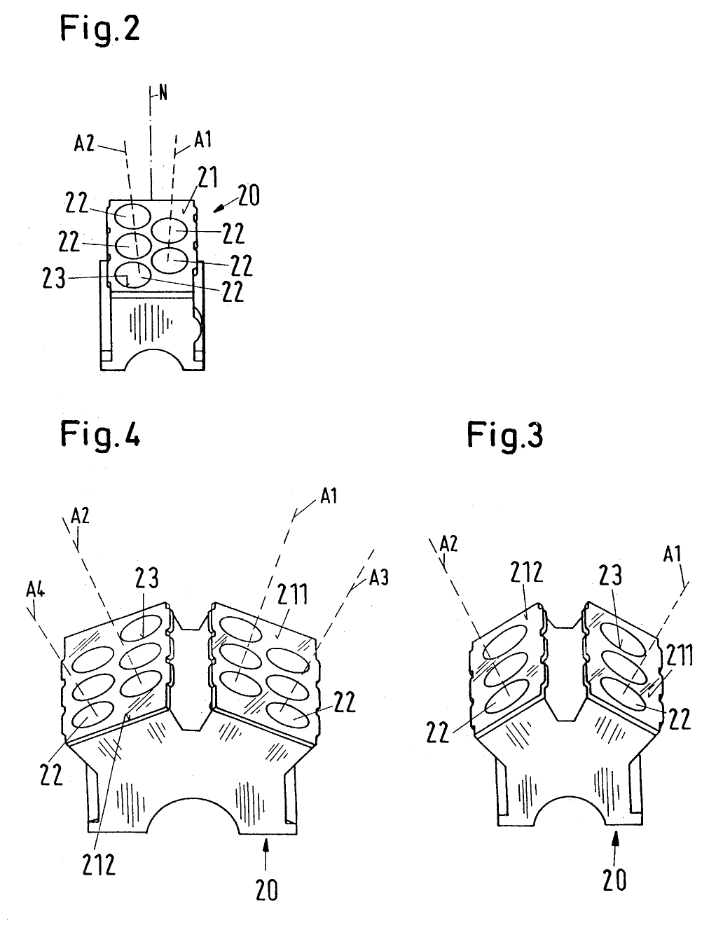

FIG. 2 a cylinder crankcase of a VR engine;

FIG. 3 a cylinder crankcase of a V engine;

FIG. 4 a cylinder crankcase of a W motor;

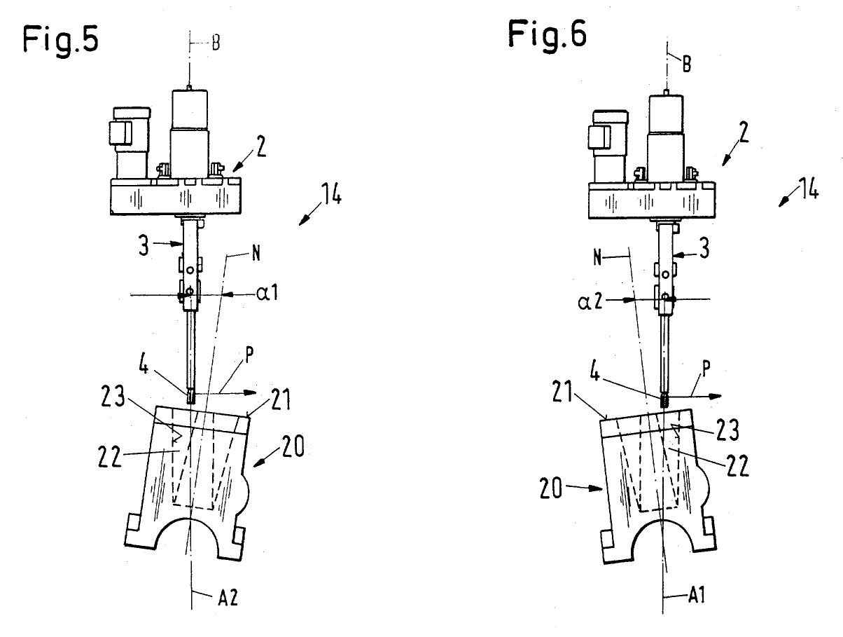

FIG. 5 the alignment of a cylinder crankcase in the coating of a first row of cylinder bores;

FIG. 6 the alignment of the cylinder crankcase of FIG. 5 in the coating of a second row of cylinder bores;

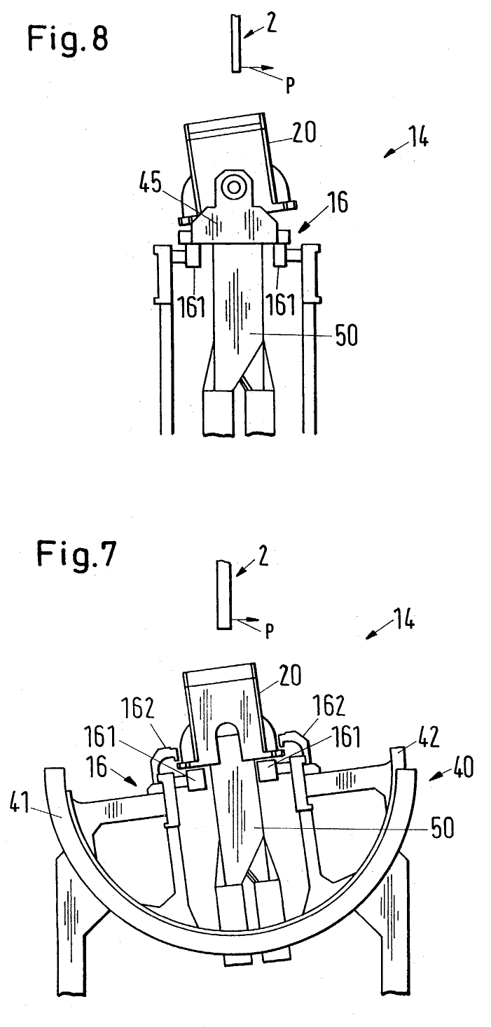

FIG. 7 a first embodiment of an apparatus in accordance with the invention;

FIG. 8 a second embodiment of an apparatus in accordance with the invention;

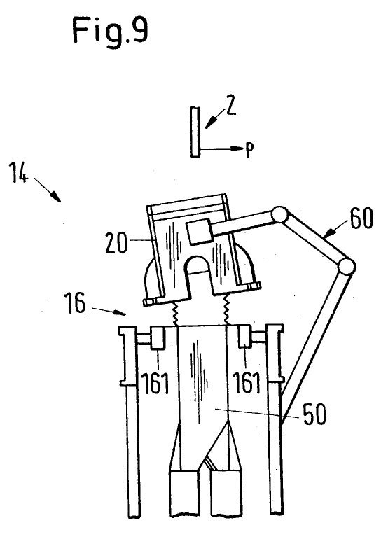

FIG. 9 a third embodiment of an apparatus in accordance with the invention; and

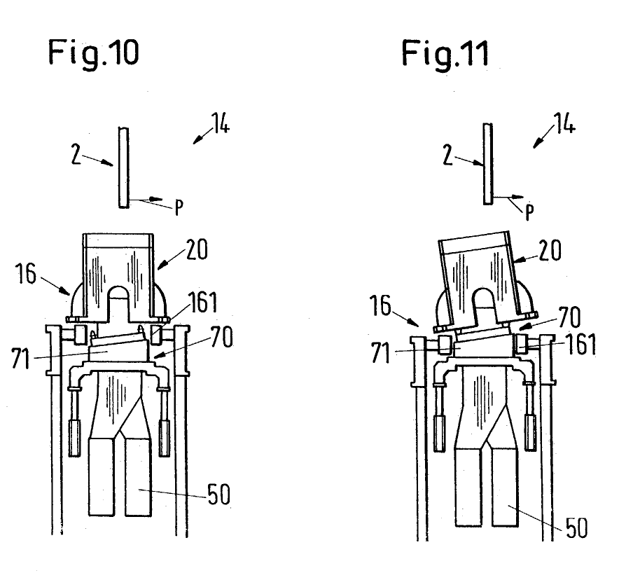

FIGS. 10, 11: representations to illustrate a forth embodiment of an apparatus in accordance with the invention.

The invention will be explained with reference to the application particularly relevant in practice in which the workpiece to be coated is the cylinder crankcase of an internal combustion engine for a passenger car. The surfaces to be coated are the cylinder running surfaces in the cylinder bores. That is, inner surfaces are being coated. It is, however, understood that the invention is not restricted to the coating of cylinder running surfaces, but is also suitable and can be used advantageously in the accordingly same manner for the thermal coating of other inner surfaces or surfaces of an inner space and/or for the thermal coating of outer surfaces and surfaces generally. Further examples of applications are the coatings of combustion chambers for aeroplane powerplants, transition pieces for industrial stationary gas turbines or the inner coating of connecting rod bearings.

Furthermore, reference is made with an exemplary character to the preferred embodiment that the thermal coating takes place by means of plasma spraying. This process is sufficiently known per se and therefore does not require any more detailed explanation here. The invention is naturally also suitable in the same sense and manner for other processes of thermal coating such as arc spraying or HVOF spraying.

FIG. 1 shows in a very schematic representation important parts of a through-flow plant—designated as a whole by the reference numeral 10 for the thermal coating of cylinder running surfaces in cylinder bores 22 in a cylinder crankcase serving as a workpiece 20. The through-flow plant 10 includes a plurality of processing stations 11, 12, 13, 14, 15 through which the workpiece 20 to be coated is transported by means of a transport system 16 which is, for example, designed as a conveyor belt or as a roller track.

As is indicated by the arrow E in FIG. 1, the workpiece 20 is supplied to the through-flow plant. The transport system 16 initially conveys the workpiece 20 in a preparation station 11. The cylinder crankcase 20 is masked here. A mask of suitable shape, not shown, is applied to the workpiece 20 and, during the further processing, protects regions of the cylinder crankcase which should not be coated, for example the surfaces in which the cylinder bores are provided, the cylinder head surfaces.

In the following processing station 12, the surfaces to be coated are prepared for the thermal coating by sandblasting.

The workpiece 20 subsequently runs through a cleaning station 13 in which an intensive cleaning takes place. Sand residues from the processing station 12, and, if necessary, still present dirt particles, are removed.

The thermal coating then takes place in the processing station 14. A rotating plasma torch is moved into the cylinder bore to be coated. The coating jet generated by the plasma torch rotates about the longitudinal axis of the cylinder bore. The coating jet describes a helix by a movement of the torch in the direction of the longitudinal axis and thus coats the inner wall of the cylinder bore 22.

After the coating, the workpiece 20 runs through a cooling station 15.

The workpiece 20 can subsequently be worked in a known manner, e.g. removal of the mask, reworking of the cylinder running surface by honing or similar processes, etc.

In the schematic representation of FIG. 1, components such as the supply and removal lines for process gases, suction devices, drives, connection lines, electrical supply devices and control devices are not shown for reasons of better clarity. A selection and control unit 17 is only indicated for the processing station 14 in which the thermal coating takes place.

The invention primarily relates to the processing station 14 in which the thermal coating takes place. Before this is explained in more detail, different designs of cylinder crankcases for internal combustion engines, for which the invention is especially suitable, should be described with reference to FIGS. 2-4.

FIG. 2 shows the cylinder crankcase for a VR engine which is here designed as a five cylinder engine, that is with five cylinder bores 22. Each cylinder bore 22 is bounded by a surface, the respective cylinder running surface 23, along which the piston moves in operation. These cylinder running surfaces 23 are thermally coated. With the cylinder crankcase 20 of the VR engine, all cylinder bores 22 are arranged in a common cylinder head surface 21, but do not extend perpendicular, but rather obliquely to the cylinder head surface 21. There are two rows of cylinder bores 22, namely the right hand row of the illustration with two bores and the left hand row of the illustration with three bores. The orientation of the cylinder bores 22 can be described by their respective longitudinal axis A1, A2 which represents the symmetry axis of the bore. The longitudinal axes A1 or A2 of the bores, which belong to the same row, each extend parallel to one another. The longitudinal axes A1 are inclined with respect to the longitudinal axes A2. The longitudinal axes A1 and A2 enclose an angle, for example, of 15 degrees. The longitudinal axes A1 and A2 extend symmetrically with respect to a normal N, which is perpendicular to the cylinder head surface 21, that is the longitudinal axis A1 of the first row includes the same angle with the normal N amount-wise as the longitudinal axis A2 of the second row.

FIG. 3 shows the cylinder crankcase 20 of a V engine which is here designed as a six cylinder engine. Two rows of cylinder bores 22 are provided which form a V arrangement. In contrast to the VR engine, in the V engine two cylinder head surfaces 211 and 212 which are inclined with respect to one another. The longitudinal axes A1 of the first row of cylinder bores 22 are each perpendicular to the first cylinder head surface 211 and the longitudinal axes A2 of the second row of cylinder bores 22 are each perpendicular to the second cylinder head surface 212.

FIG. 4 shows the cylinder crankcase 22 of a W engine which is here designed as a twelve cylinder engine. Four rows of three cylinder bores 22 each are provided. Similar to the V engine, two cylinder head surfaces 211 and 212 are also provided with the W engine and are inclined with respect to one another, with two rows of cylinder bores 22, however, being provided in each cylinder head surface 211 or 212 respectively with the W engine. Within a row, the longitudinal axes A1, A2, A3 or A4 each extend parallel to one another. The longitudinal axes A1-A4 are inclined pair-wise with respect to one another, i.e. in general none of the axes A1 to A4 extends parallel to another of the axes A1 to A4.

The cylinder crankcases 20 illustrated in FIGS. 2-4 have in common that each of these cylinder crankcases 20 has at least two rows of cylinder bores 22, with the longitudinal axes Al of the cylinder bores 22 of the first row not extending parallel, but in an inclined manner to the longitudinal axes A2 of the cylinder bores 22 of the second row.

In thermal coating, in particular in plasma spraying with a rotating plasma torch, it has proven to be advantageous to orient the surface to be coated perpendicularly, because then a particularly uniform layer application can be realised. For the coating of the cylinder running surfaces 23, this means that the longitudinal axis A1, A2, A3 or A4 should each be vertical during the coating.

In accordance with the invention, it is now proposed to provide adjustment means which align the workpiece 20 such that the surface to be coated is perpendicular.

In this connection, “vertical” or “vertical direction” designates, as generally usual, the direction in which gravity works. Within the framework of this application, a surface or a surface element is considered to be “aligned vertically” or “vertically oriented” when the surface normal vector of this surface or of this surface element is perpendicular to the vertical direction. In the case of the cylinder bores 22, or of the cylinder running surface 23, this means that the symmetry axis, that is the longitudinal axis A1, A2, A3, A4 of the cylinder bore 22, is aligned vertically.

The principle of the method in accordance with the invention or of the apparatus in accordance with the invention becomes clear with reference to FIG. 5 and FIG. 6. FIG. 5 shows the workpiece 20, here the cylinder crankcase of a VR engine (as shown in FIG. 2) in the processing station 14 in which the thermal coating takes place. A torch 2 is provided to produce a coating jet which is symbolically represented by the arrow P. The torch 2 is designed as a rotatable plasma torch and includes a rod 3 which extends in the direction of the longitudinal axis B of the torch 2. At the lower end of the rod in the illustration, a nozzle 4 is provided out of which the coating jet P is discharged. The nozzle 4 is arranged such that the coating jet P is discharged perpendicular to the longitudinal axis B of the torch. The torch 2 is arranged in the processing station 14 such that its longitudinal axis B extends in a vertical manner. The coating jet P is consequently discharged substantially perpendicular to the vertical direction.

The workpiece 20 is aligned in the processing station 14 by means of adjustment means described further below such that the surface to be coated, here the cylinder running surface 23, is aligned perpendicular to the coating jet P and thus vertically.

In the position represented in FIG. 5, the workpiece 20 is aligned such that the longitudinal axis A2 of the left hand row of cylinder bores 22 in the illustration extends vertically and thus parallel or coincidentally to the longitudinal axis B of the torch 2. The cylinder crankcase 20 is therefore tilted by an angle α1 which corresponds to the angle between the normal N of the cylinder head surface 21 and the longitudinal axis A2. The cylinder running surface 23 to be coated is thus vertical. During the coating, the coating jet rotates about the longitudinal axis B of the torch 2. By a linear movement of the torch 2 or of the rod 3, it is then achieved that the coating jet B, following a helix, coats the whole cylinder running surface 23, with it always being insured that the surface to be coated is perpendicular to the coating jet P and is aligned vertically.

After all cylinder bores 22 of the left hand side in the illustration have been coated, the cylinder crankcase 20 is brought into the position shown in FIG. 6 by means of the adjustment means. The cylinder bores 22 of the right hand row in the illustration are now aligned vertically, that is the longitudinal axis A1 is parallel to or coincidental with the longitudinal axis B of the torch 2. The normal N of the cylinder head surface 21 is tilted through an angle α2 with respect to the longitudinal axis B of the torch, that is the cylinder crankcase 22 was tilted in total through the angle α1+α2 (generally the amount of α1 in a VR motor is equal to α2). In the orientation shown in FIG. 6, the right hand row of cylinder bores 22 in the illustration can therefore be coated, with it being ensured that the cylinder running surface 23 to be coated is always aligned vertically during coating and is hit by the coating jet substantially perpendicularly.

The invention provides a quite substantial increase in efficiency and an improvement in profitability in particular with regard to automated mass production. The cylinder bores of cylinder crankcases of all engine types, in particular also those of VR, V and W engines can be coated in an automated manner in one single run-through or pass. It is no longer necessary to run two passes—in the case of the W engine four passes—through the through-flow plant in order to coat all cylinder bores.

Different examples of the apparatus in accordance with the invention, and in particular of the adjustment means, will now be explained in the following.

FIG. 7 shows a first example of an apparatus in accordance with the invention. In this example, the adjustment means include an adjusting device 40 with which the total transport system 16 is tiltable and/or pivotable in the region of the processing station 14. The adjusting device 40 includes a stationary bearing shell 41 which is cylindrically curved. A holder 42 is guided in this bearing shell 41. The transport system 16 is fixed in place at the holder 42. The transport system 16 is here designed as a roll track with rollers 161. The workpiece 20 is fixed on the transport system 16 by means of clamps 162. Furthermore, the workpiece 20 is in effective connection with a suction apparatus 50 which sucks away gas and excess coating material during the coating. In this embodiment, the total transport system 16 is tilted in the region of the coating station 14 in that the holder 42 is moved in the bearing shell 41 until the workpiece is correctly aligned. Then the holder 42 is fixed in place with respect to the bearing shell 41.

For coating, the cylinder crankcase 20 is moved into the processing station 14, fixed—where necessary—on the transport system 16 by means of the clamps 162 and the suction apparatus 50 is positioned. Now, the entire unit consisting of the transport system 16, workpiece 20—including the masking—and the suction apparatus 50 is tilted by means of the adjusting device 40 such that the first row of cylinder bores 22 is aligned vertically. This row is coated by means of the torch 2. Subsequently, the entire unit is tilted about the angle which is required to align the second row of cylinder bores 22 vertically. After all cylinder bores 22 have been coated in this manner, the cylinder crankcase 20 is brought into its normal position and can be transferred into the next station.

In a second example, which is illustrated in FIG. 8, the transport system 16 is mounted in a stationary manner. A holder 45 is provided on the transport system and the workpiece can be tilted and/or pivoted with respect to the transport system 16 by means of this. The holder 45 is designed, for example, as an adapter pallet, with the angle of the adapter pallet being adjustable so that the base of the workpiece 20 is adjustably tiltable and/or pivotable relative to the surface of the transport system 16. The workpiece 20 moves on the holder 45 designed as an adapter pallet into the processing station 14 for processing and is positioned there. Then, the suction apparatus 50 is matched to the workpiece 20, preferably automatically. If necessary, the mask is also adapted. The workpiece 20, including the masking and the suction apparatus 50, is now tilted until the surface to be coated is vertical. After the first row of cylinder bores has been coated, the workpiece 20, including the masking and the connected suction apparatus 50, is tilted until the next row of cylinder bores 22 is aligned vertically and can be coated. After all cylinder bores 22 have been coated in this manner, the cylinder crankcase 20 is brought into its normal position and can be transferred into the next station.

FIG. 9 shows a third example. In this example, the adjusting means include a positioning device 60 with which the workpiece 20 can be gripped, aligned and held in the processing station 14 during coating. The positioning device 16 is made as a flexible handling system, for example with a controllable gripping arm or as a robot unit. The positioning device 60 grasps the workpiece 20 in the processing station 14 and aligns it such that the surface to be coated is vertical. After the first row of cylinder bores has been coated, the workpiece 20, including the masking and connected suction device 50, is tilted until the next row of cylinder bores 22 is aligned vertically and can be coated. After all cylinder bores 22 have been coated in this manner, the positioning device places the cylinder crankcase in its normal position onto the transport system 16, which transports the workpiece 20 further.

FIGS. 10 and 11 show a fourth example in which the adjustment means include a lifting device 70 with which the workpiece 20 can be lifted at least in part from the transport system 16. FIG. 10 shows the workpiece which stands on the rollers 161 of the transport system 16 in the processing station 14. The lifting device 70 is provided underneath the rollers 161 of the transport system in the illustration, said lifting device 70 including an obliquely extending lifting element 71. As soon as the workpiece 20 is positioned beneath the torch 2, the lifting element 71 is moved upwardly between the rollers 161 of the transport system and, due to its oblique extent, brings the workpiece 20 into a tilted position which is shown in FIG. 11. The workpiece is thereby alignable such that the cylinder running surface to be coated stands vertically. For the coating of the second row of cylinder bores, different variants can be provided. For instance, it is possible, for example, to design the lift element 71 adjustably. For example, the lift element 71 can be supported such that its right hand side in the illustration or its left hand side in the illustration can be raised alternatively.

Another variant consists of providing two lifting devices 70 which are arranged behind one another and in a mirror fashion with respect to one another. The workpiece 20 is then first positioned over the first lifting device 70 and tilted by means of this such that the first row of cylinder bores is vertical. After the coating of this row has taken place, the workpiece 20 is positioned over the second lifting device 70 which tilts the workpiece 20 in the reverse direction so that the second row of cylinder bores can now be coated.

It therefore becomes possible by the invention to coat all cylinder bores of any desired cylinder crankcase of an internal combustion engine in only one processing run in a through-flow plant.

This is also in particular possible with such cylinder crankcases which have different bore angles, that is e.g. with VR, V or W engines. This means—in particular with regard to industrial mass production and large-scale production—a substantial increase in efficiency and a lowering of the manufacturing cost and complexity.

Measures will now only be explained which apply in the same manner and sense to all examples.

The vertical alignment in accordance with the invention of the surface to be coated preferably takes place automatically. Depending on the orientation of the surface to be coated, the required tilting movement and/or pivoting movements of the workpiece 20 are entered or programmed, for example into the selection and control device 17. After the workpiece 20 has run into the processing station, the workpiece 20 is then automatically brought into the correct alignment or successively brought into the different coating positions by means of the adjustment means 20.

Sensors, for example optical sensors, can be provided to monitor the correct alignment of the workpiece.

It is furthermore possible to provide two or more torches 2 operable in parallel in the processing station 14. Two or more surfaces can thereby be coated simultaneously. In the case of the coating of cylinder bores in the cylinder crankcase, two non-adjacent bores are preferably coated simultaneously during simultaneous coating in order to avoid too much local heating, particularly in the usually thin walls between adjacent bores.

As already mentioned, the invention is naturally also suitable for the coating of surfaces other than cylinder running surfaces in cylinder crankcases. Depending on the geometry of the surface, it is also possible to trace the surface to be coated during coating. If, for example, the surface to be coated is curved in the direction of the longitudinal axis B of the torch 2, then its orientation or alignment can be changed automatically during the coating process so that the respective region of the surface to be coated is aligned vertically.

1. An apparatus for the thermal coating of a surface of a workpiece (20) comprising a torch (2) for the production of a coating jet (P), wherein the torch (2) is arranged in a processing station (14) such that the coating jet (P) extends substantially perpendicular to the vertical direction, and also comprising adjustment means (40; 45; 60; 70) which align the workpiece (20) such that the surface to be coated is perpendicular to the coating jet (P) during the coating process.

2. An apparatus in accordance with claim 1, comprising a transport system (16) which transports the workpiece (20) into the processing station (14) and brings it into a processing position there.

3. An apparatus in accordance with claim 1 or claim 2, in which the adjustment means include an adjusting device (40) with which the transport system (16) is tiltable and/or pivotable at least in the region of the processing station (14).

4. An apparatus in accordance with any one of the preceding claims, wherein a holder (45) is provided on the transport system for the reception of the workpiece (20), with which holder (45) the workpiece (20) is tiltable and/or pivotable with respect to the transport system (16).

5. An apparatus in accordance with any one of the preceding claims comprising a positioning device (60) with which the workpiece (20) can be gripped, aligned and held in the processing station (14) during coating.

6. An apparatus in accordance with any one of the preceding claims, comprising a lifting device (70) with which the workpiece (20) can be raised at least in part from the transport system (16).

7. An apparatus in accordance with any one of the preceding claims, wherein at least two torches (2) are provided to coat two surfaces simultaneously.

8. An apparatus in accordance with any one of the preceding claims, in which the torch (2) is a plasma torch, in particular a rotatable plasma torch.

9. A method for the thermal coating of a workpiece (20), wherein a coating jet (P) is produced by a torch (2), said coating jet (P) extending substantially perpendicular to the vertical direction and wherein the workpiece (20) is positioned by adjustable adjustment means (40; 45; 60; 70) such that the surface to be coated is perpendicular to the coating jet (P) during the coating process.

10. Use of an apparatus in accordance with any one of claims 1-8, or of a method in accordance with claim 9, for the coating of inner surfaces, in particular of cylinder running surfaces (23) in cylinder bores (22) of a cylinder crankcase (20) especially of a cylinder crankcase which has at least two cylinder bores (22) whose longitudinal axes (A1, A2, A3, A4) are not parallel to one another.
